(19) United States
(12) Patent Application Publication
(10) Pub. No.: US 2026/0244564 A1
(43) Pub. Date: Aug. 20, 2026

(54) METHOD AND NON-TRANSITORY COMPUTER-READABLE STORAGE MEDIUM AND APPARATUS FOR GARBAGE COLLECTION IN FLASH STORAGE DEVICE

(71) Applicant: Silicon Motion, Inc., Zhubei City (TW)

(72) Inventor: Huan-Jung YEH, Zhubei City (TW)

(73) Assignee: Silicon Motion, Inc., Zhubei City (TW)

(21) Appl. No.: 19/097,365

(22) Filed: Apr. 1, 2025

(30) Foreign Application Priority Data
Feb. 17, 2025 (TW) 114105761

(51) Int. Cl. G06F 12/02

(52) U.S. Cl. CPC G06F 12/0246; G06F 2212/7205

(57) ABSTRACT

The invention introduces a method for garbage collection (GC) in a flash storage device, performed by a processing unit, to include: considering data blocks whose hot-data scores are lower than a threshold as block candidates according to records in a hot-data scoring table; sorting the block candidates in ascending order according to valid page counts (VPCs) associated with the block candidates; starting from the candidate block with a smallest VPC, selecting source blocks from sorted block candidates in which valid user data can fill one destination block; and programming valid user data of the source blocks into a destination block in a flash module.

### CROSS-REFERENCE TO RELATED APPLICATIONS

This application claims the benefit of priority to patent application No. 114105761, filed in Taiwan on Feb. 17, 2025; the entirety of which is incorporated herein by reference for all purposes.

### BACKGROUND

The disclosure generally relates to storage devices and, more particularly, to a method, a non-transitory computer-readable storage medium and an apparatus for garbage collection in a flash storage device.

Flash memory devices typically include NOR flash devices and NAND flash devices. NOR flash devices are random access—a host side accessing a NOR flash device can provide the device any address on its address pins and immediately retrieve data stored in that address on the device's data pins. NAND flash devices, on the other hand, are not random access but serial access. It is not possible for NAND to access any random address in the way described above. Instead, the host side has to write into the device a sequence of bytes which identifies both the type of command requested (e.g. read, write, erase, etc.) and the address to be used for that command. The address identifies a page (the smallest chunk of flash memory that can be written in a single operation) or a block (the smallest chunk of flash memory that can be erased in a single operation), and not a single byte or word.

After numerous accesses, a physical page may include valid and invalid pages (also referred to as stale pages), in which the valid pages store valid user data while the invalid pages store invalid (old) user data. When detecting that available space of a storage device is lower than a threshold, a flash controller may issue read instructions to direct the storage device to read and collect user data of the valid pages of one or more physical blocks (also referred to as source blocks), and then, issue write instructions to direct the storage device to program the collected user data into empty physical pages of an spare or active block (also referred to as destination blocks), thereby making the data block storing no valid user data be able to erase to become spare blocks. The data block after being erased provides space for storing more data. The above steps are referred to as a Garbage Collection (GC) process. However, a poorly-designed GC process would degrade the overall performance of the storage device.

### SUMMARY

In an aspect of the invention, an embodiment introduces a method for garbage collection (GC) in a flash storage device, performed by a processing unit, to include the following steps: considering data blocks whose hot-data scores are lower than a threshold as block candidates according to records in a hot-data scoring table; sorting the block candidates in ascending order according to valid page counts (VPCs) associated with the block candidates; starting from the candidate block with a smallest VPC, selecting source blocks from sorted block candidates in which valid user data can fill one destination block; and programming valid user data of the source blocks into a destination block in a flash module.

In another aspect of the invention, an embodiment introduces a non-transitory computer-readable storage medium having stored therein program code that, when loaded and executed by a processing unit, causes the processing unit to perform the method for GC in a flash storage device as described above.

In still another aspect of the invention, an embodiment introduces an apparatus for GC in a flash storage device, to include: a flash interface (I/F), coupled to a flash module; and a processing unit, coupled to the flash I/F. The processing unit is arranged operably to: consider data blocks whose hot-data scores are lower than a threshold as block candidates according to records in a hot-data scoring table; sort the block candidates in ascending order according to VPCs associated with the block candidates; starting from the candidate block with a smallest VPC, select source blocks from sorted block candidates in which valid user data can fill one destination block; and driving the flash I/F to program valid user data of the source blocks into a destination block in the flash module.

Both the foregoing general description and the following detailed description are examples and explanatory only, and are not restrictive of the invention as claimed.

### BRIEF DESCRIPTION OF THE DRAWINGS

FIG. 1 is the system architecture of an electronic apparatus according to an embodiment of the invention.

FIG. 2 is a schematic diagram illustrating a flash module according to an embodiment of the invention.

FIG. 3 is a schematic diagram showing the hardware architecture of a portion of a NAND flash unit according to an embodiment of the invention.

FIG. 4 is a flowchart illustrating a method for a garbage collection (GC) process according to an embodiment of the invention.

### DETAILED DESCRIPTION

Reference is made in detail to embodiments of the invention, which are illustrated in the accompanying drawings. The same reference numbers may be used throughout the drawings to refer to the same or like parts, components, or operations.

Certain aspects and embodiments of this disclosure are provided below. Some of these embodiments may be applied independently and some of them may be applied in conjunction as would be apparent to those of skill in the art. In the following description, for the purposes of explanation, specific details are set forth in order to provide a thorough understanding of aspects of the application. However, it will be apparent that various embodiments may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that changes may be made in the function and arrangement of elements without departing from the spirit and scope of the application as set forth in the claims.

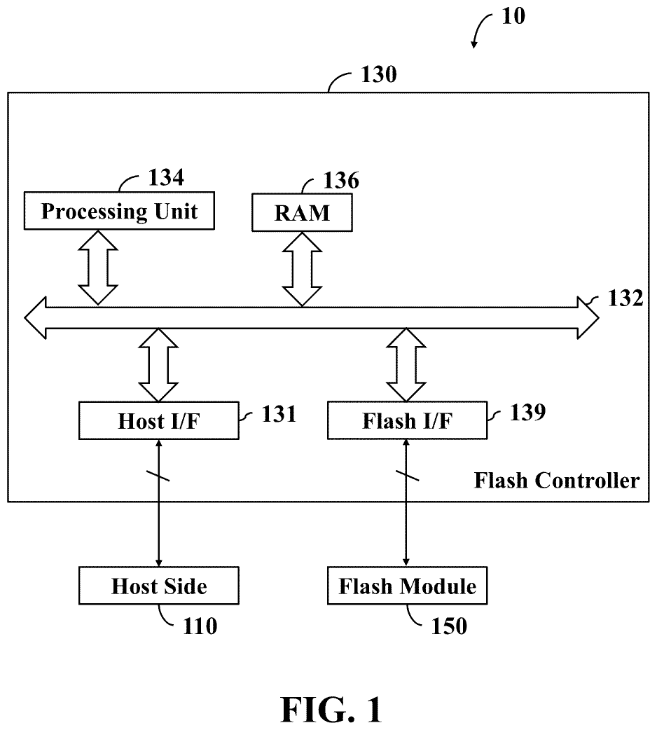

Refer to FIG. 1. The electronic apparatus 10 includes the host side 110, the flash controller 130 and the flash module 150, and the flash controller 130 and the flash module 150 may be collectively referred to as a device side. The electronic apparatus 10 may be included in a Personal Computer (PC), a laptop PC, a tablet PC, a mobile phone, a digital camera, a digital recorder, a smart television, a smart freezer, an automotive electronics system or other consumer electronic products. The host side 110 and the host interface (I/F) 131 of the flash controller 130 may communicate with each other by Universal Serial Bus (USB), Advanced Technology Attachment (ATA), Serial Advanced Technology Attachment (SATA), Peripheral Component Interconnect Express (PCI-E), Universal Flash Storage (UFS), Embedded Multi-Media Card (eMMC) protocol, or others. The flash I/F 139 of the flash controller 130 and the flash module 150 may communicate with each other by a Double Data Rate (DDR) protocol, such as Open NAND Flash Interface (ONFI), DDR Toggle, or others. The flash controller 130 includes the processing unit 134 and the processing unit 134 may be implemented in numerous ways, such as with general-purpose hardware (e.g., a microcontroller unit, a single processor, multiple processors or graphics processing units capable of parallel computations, or others) that is programmed using firmware and/or software instructions to perform the functions recited herein. The processing unit 134 may receive host commands from the host side 110 through the host I/F 131, such as write commands, read commands, discard commands, erase commands, etc., schedule and execute the host commands. The flash controller 130 includes the Random Access Memory (RAM) 136, which may be implemented in a Dynamic Random Access Memory (DRAM), a Static Random Access Memory (SRAM), or the combination thereof, for allocating space as a data buffer storing user data (also referred to as host data) that has been obtained from the host side 110 and is to be programmed into the flash module 150, and that has been read from the flash module 150 and is to be output to the host side 110. The RAM 136 stores necessary data in execution, such as variables, data tables, data abstracts, host-address to flash-address mapping (H2F) tables, flash-address to host-address mapping (F2H) tables, or others. The flash h/F 139 includes a NAND flash controller (NFC) to provide functions that are required to access the flash module 150, such as a command sequencer, a Low Density Parity Check (LDPC) encoder/decoder, etc.

The flash controller 130 may be equipped with the bus architecture 132 to couple components to each other to transmit data, addresses, control signals, etc. The components include but not limited to the host I/F 131, the processing unit 134, the RAM 136 and the flash I/F 139. A direct memory access (DMA) circuitry of a component moves data between specific components through the bus architecture 132 according to instructions or control signals. For example, a DMA circuitry of the host I/F 131 or the flash I/F 139 may migrate data in a specific data buffer thereof to a specific address of the RAM 136, migrate data in a specific address of the RAM 136 to a specific data buffer thereof, and so on.

The flash module 150 provides huge storage space typically in hundred Gigabytes (GBs), or even several Terabytes (TBs), for storing a wide range of user data, such as high-resolution images, video files, etc. The flash module 150 includes control circuitries and memory arrays containing memory cells, such as being configured as Single Level Cells (SLCs), Multi-Level Cells (MLCs), Triple Level Cells (TLCs), Quad-Level Cells (QLCs), or any combinations thereof. The processing unit 134 programs user data into a designated address (a destination address) of the flash module 150 and reads user data from a designated address (a source address) thereof through the flash I/F 139. The flash I/F 139 may use several electronic signals including a data line, a clock signal line and control signal lines for coordinating the command, address and data transfer with the flash module 150. The data line may be used to transfer commands, addresses, read data and data to be programmed; and the control signal lines may be used to transfer control signals, such as Chip Enable (CE), Address Latch Enable (ALE), Command Latch Enable (CLE), Write Enable (WE), etc.

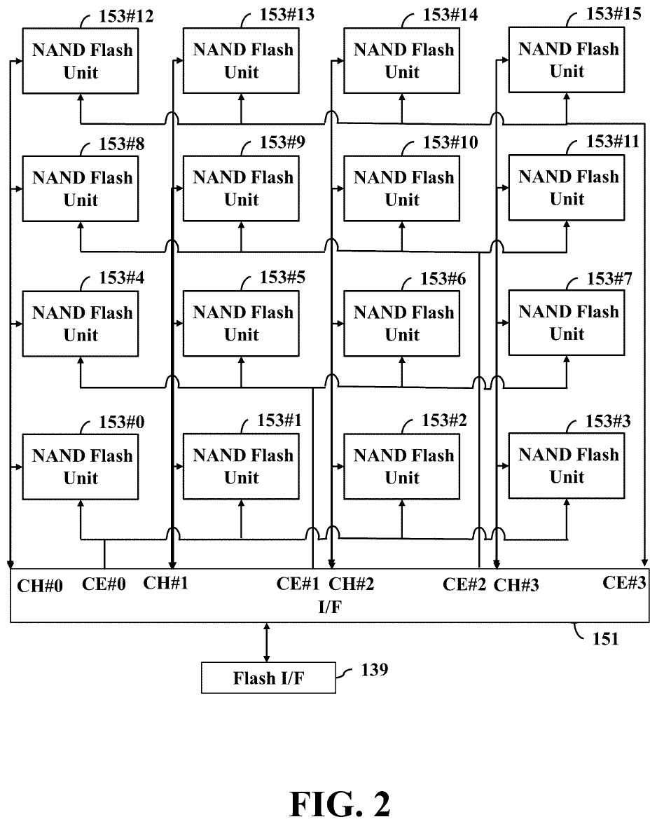

Refer to FIG. 2. The I/F 151 of the flash module 150 may include four I/O channels (hereinafter referred to as channels) CH #0 to CH #3 and each is connected to four NAND flash units, for example, the channel CH #0 is connected to the NAND flash units 153 #0, 153 #4, 153 #8 and 153 #12. Each NAND flash unit can be packaged in an independent die. The flash I/F 139 may issue one of the CE signals CE #0 to CE #3 through the I/F 151 to activate the NAND flash units 153 #0 to 153 #3, the NAND flash units 153 #4 to 153 #7, the NAND flash units 153 #8 to 153 #11, or the NAND flash units 153 #12 to 153 #15, and read data from or program data into the activated NAND flash units in parallel.

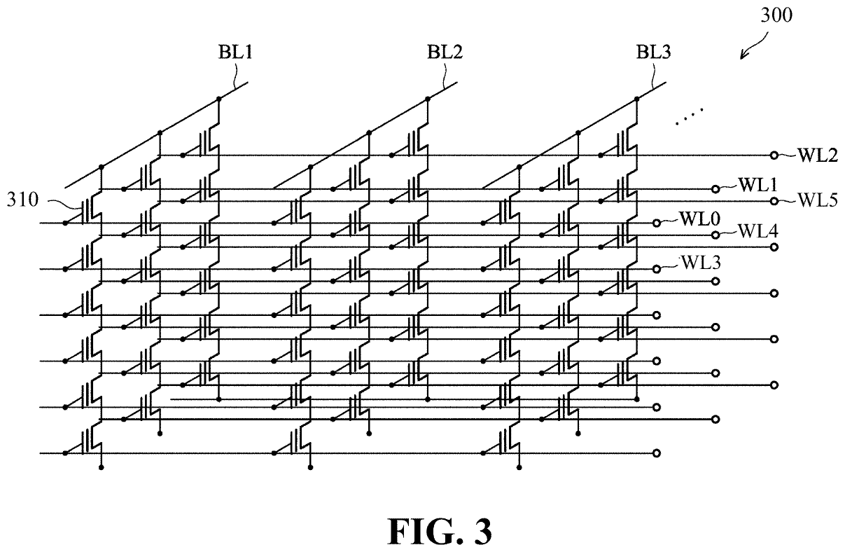

Refer to FIG. 3 showing the hardware architecture of a portion of a NAND flash unit. Each NAND flash unit may contain a plurality of memory blocks (e.g. the memory block 300) and the memory block 300 contains multiple memory cells, such as floating gate transistors (e.g. the floating gate transistor 310), or other charge trap devices. The structure of the memory block 300 includes bit lines and word lines. For brevity, only the bit lines BL1 to BL3 and the word lines WL0 to WL5 are labeled in FIG. 3. For example, the floating gate transistors on each of the word lines WL0 to WL2 and WL3 to WL5 store one or more pages of data.

Each NAND flash unit may include multiple data planes, each data plane may include multiple physical blocks. In order to improve the data programming and data reading efficiency, designated physical pages of multiple data planes across multiple NAND flash units are organized into one super page (SP). For example, in the exemplary configuration as shown in FIG. 2, each NAND flash unit includes four data planes, and each data plane includes at least one physical page of four kilobytes (KB). One SP stores user data of 256 KB (=4 channels×4 CE×4 data planes×4 KB). One super block (SB) is composed of multiple SPs. In some embodiments, any SB may be configured as a Single Level Cell (SLB) SB and each SP in the SLC SB is called SLC SP. In alternative embodiments, any SB may be configured as a Multi-Level Cell (MLC) SB and each SP in the MLC SB may be a most significant bit (MSB) SP or a least significant bit (LSB) SP. In still alternative embodiments, any SB may be configured as a Triple Level Cell (TLC) SB and each SP in the TLC SB may be an MSB SP, a center significant bit (CSB) SP or an LSB SP. In still alternative embodiments, any SB may be configured as a Quad-Level Cell (QLC) SB and each SP in the QLC SB may be a top significant bit (TSB) SP, an MSB SP, a CSB SP or an LSB SP.

In some embodiments, one logical block address (LBA) managed by the host side 110 may represent user data of 512 bytes (B), and each physical page may be divided into eight sections in 512 B. An LBA number is referred to as a logical address managed by the host side 110. An SB, a physical page and a section may be identified by a super-block number, a physical page number and a section number, respectively, and the combination of the numbers is referred to as a physical address of the flash module 150. In alternative embodiments, one host page number managed by the host side 110 may represent user data of 4 KB and each physical page is not necessary to divide into sections. A host page number is referred to as a logical address managed by the host side 110. An SB and a physical page may be identified by a super-block number and a physical page number, respectively, and the combination of the numbers is referred to as a physical address of the flash module 150.

Each SB is labeled as a data block or a current block according to its function. The processing unit 134 may select an empty SB as the current block for preparing to program user data received from the host side 110. In order to improve the efficiency of data programming, the user data provided by the host side 110 is programmed in parallel into designated physical blocks of the SB across multiple NAND flash units. The processing unit 134 maintains the F2H table for each current block. Each F2H table contains multiple records. Each record stores the information indicating which logical address of user data that is associated with (or mapped by) each physical page in the current block. The records in the F2H table are stored in the order of the page numbers of physical pages in the current block. The logical address may be expressed in a logical block address (LBA), a host page number or other expression and is managed by the host side 110. For example, each LBA or host page is associated with the user data in 4K bytes. The processing unit 134 may drive the flash I/F 139 to program the corresponding F2H table in the RAM 136 into the data region of the designated physical page (for example, the last physical page) of one current block after all physical pages of this current block are fully stored in user data or the remaining physical pages of this current block are filled with dummy values. The current block is changed to the data block after the corresponding F2H table has been programmed into the flash module 150, and the user data stored in the data block cannot be modified. Since user data of the same logical addresses may be programmed into different physical pages in one current block at different time points, some physical pages of this current block may contain invalid data, so that the processing unit 134 calculates the valid page count (VPC) of this current block. Subsequently, the processing unit 134 selects another empty SB as a new current block.

In some embodiments, in addition to the corresponding F2H table, the processing unit 134 drives the flash I/F 139 to write the initial VPC into the metadata region of the designated physical page (for example, the last physical page) in one current block. In alternative embodiments, the processing unit 134 maintains a VPC table in the RAM 136 to store the VPCs of all data blocks. Each time a data block is generated, the processing unit 134 updates the content of VPC table to append information about the new data block and its VPC. The processing unit 134 drives the flash I/F 139 to program the up-to-date VPC table into the designated physical address of the flash module 150 after updating the VPC table for a predetermined number of data blocks.

In addition to programming the F2H table into the designated physical page of the current block, the processing unit 134 updates the H2F table according to the content of F2H table, so that the processing unit 134 when executing host read commands searches the H2F table for the physical addresses user data of particular logical addresses are physically stored in later. The H2F table contains multiple records arranged in the order of the logical addresses and each record stores information indicating which physical address user data of the corresponding logical address is physically stored in. However, because the RAM 136 cannot provide enough space to store the whole H2F table for the processing unit 134, the whole H2F table is divided into multiple H2F sub-tables and the H2F sub-tables are stored in the flash module 150, so that only necessary H2F sub-table or sub-tables are read from the flash module 150 and stored in the RAM 136 for fast look-up when data read operations are performed in the future.

After numerous accesses, a physical page may include valid and invalid pages (also referred to as stale pages), in which the valid pages store valid user data while the invalid pages store invalid (old) user data. When detecting that available space of the flash module 150 is lower than a threshold, the flash controller 130 (specifically, the processing unit 134) may issue read instructions to direct the flash module 150 to read and collect user data of the valid pages of one or more data blocks (also referred to as source blocks), and then, issue write instructions to direct the flash module 150 to program the collected user data into empty SBs (also referred to as destination blocks), thereby making the data block storing no valid user data be able to erase to become spare blocks. The data block after being erased provides space for storing more data. The above operations are referred to as a Garbage Collection (GC) process. The whole GC process includes three stages: selection and sequence arrangement of source blocks; arrangement of valid user data in the destination block; and migration of valid user data and release of source blocks. However, if the selected source blocks contain lots of hot data (that is, frequently updated data), the hot data newly programmed into the destination block would soon become invalid again due to future updates by the host side 110. Therefore, a large amount of hot-data migration during the GC process increases the write amplification factor (WAF), thereby reducing the overall performance of the device side.

In order to avoid increasing WAF due to a large amount of hot-data migration during the GC process, an embodiment of the invention introduces a mechanism to avoid selecting data blocks containing more valid hot data (also called hot-data blocks) as source blocks. In addition to the VPC table, the processing unit 134 maintains the hot-data scoring table including multiple records. Each record stores a hot-data score of the corresponding data block. The higher the hot-data score, the more hot data is contained in the corresponding data block.

During the data write operation for executing a host write command, the processing unit 134 updates the hot-data score of the current block according to access frequency information carried in the host write command. The hot-data score of the current block is increased by the first value when the access frequency information indicates that the logical address range of user data to be written, which is instructed by the host write command, has infrequent writes and infrequent reads. The hot-data score of the current block is increased by the second value when the access frequency information indicates that the logical address range of user data to be written, which is instructed by the host write command, has infrequent writes and frequent reads. The hot-data score of the current block is increased by the third value when the access frequency information indicates that the logical address range of user data to be written, which is instructed by the host write command, has frequency writes and frequent reads. The first value, the second value and the third value are integers greater than 0, where the first value is smaller than the second value, and the second value is smaller than the third value.

For example, bits 0 to 3 of Command Dword 13 of the host write command include the access frequency attribute according to the “NVM Command Set Specification, Revision 1.0” released on May 18, 2021. The value of access frequency attribute being “0h” represents that no frequency information is provided. The value of access frequency attribute being “1h” represents typical number of reads and writes expected for the LBA range. The value of access frequency attribute being “2h” represents infrequent writes and infrequent reads to the LBA range indicated. The value of access frequency attribute being “3h” represents infrequent writes and frequent reads to the LBA range indicated. The value of access frequency attribute being “4h” represents frequency writes and infrequent reads to the LBA range indicated. The value of access frequency attribute being “5h” represents frequency writes and frequent reads to the LBA range indicated. The value of access frequency attribute being “6h” represents one time read to the LBA range indicated. The processing unit 134 increases the hot-data score of the current block by 1 when the value of access frequency attribute carried in the executed host write command is “3h”. The processing unit 134 increases the hot-data score of the current block by 2 when the value of access frequency attribute carried in the executed host write command is “4h”. The processing unit 134 increases the hot-data score of the current block by 3 when the value of access frequency attribute carried in the executed host write command is “5h”. Otherwise, the processing unit 134 maintains the hot-data score of the current block.

In alternative embodiments, the hot-data score of the current block is increased by the multiplication of the first value by the length of the logical address range when the access frequency information indicates that the logical address range of user data to be written, which is instructed by the host write command, has infrequent writes and infrequent reads. The hot-data score of the current block is increased by the multiplication of the second value by the length of the logical address range when the access frequency information indicates that the logical address range of user data to be written, which is instructed by the host write command, has infrequent writes and frequent reads. The hot-data score of the current block is increased by the multiplication of the third value by the length of the logical address range when the access frequency information indicates that the logical address range of user data to be written, which is instructed by the host write command, has frequency writes and frequent reads. The first value, the second value and the third value are integers greater than 0, where the first value is smaller than the second value, and the second value is smaller than the third value.

In some embodiments, the processing unit 134 drives the flash I/F 139 to program the latest hot-data score of the current block into the metadata region of the designated physical page (e.g. the last physical page) of the current block. In alternative embodiments, the processing unit 134 maintains the hot-data scoring table in the RAM 136 for storing the hot-data scores of all data blocks. Each time a new data block is generated, the processing unit 134 updates the content of hot-data scoring table to append a new record for storing information about the hot-data score of the new data block. The processing unit 134 drives the flash I/F 139 to program the up-to-date hot-data scoring table into the designated physical address of the flash module 150 after updating the hot-data scoring table for a predetermined number of data blocks.

In some embodiments, the processing unit 134 during the data read operation for executing a host read command updates the hot-data scoring table according to access frequency information carried in the host read command. Each of the hot-data scores of all related data blocks is increased by the first value when the access frequency information indicates that the logical address range of user data to be read, which is instructed by the host read command, has infrequent writes and infrequent reads. Each of the hot-data scores of all related data blocks is increased by the second value when the access frequency information indicates that the logical address range of user data to be read, which is instructed by the host read command, has infrequent writes and frequent reads. Each of the hot-data scores of all related data blocks is increased by the third value when the access frequency information indicates that the logical address range of user data to be read, which is instructed by the host read command, has frequency writes and frequent reads. The first value, the second value and the third value are integers greater than 0, where the first value is smaller than the second value, and the second value is smaller than the third value.

For example, bits 0 to 3 of Command Dword 13 of the host read command include the access frequency attribute according to the “NVM Command Set Specification, Revision 1.0” released on May 18, 2021. The value of access frequency attribute being “0h” represents that no frequency information is provided. The value of access frequency attribute being “1h” represents typical number of reads and writes expected for the LBA range. The value of access frequency attribute being “2h” represents infrequent writes and infrequent reads to the LBA range indicated. The value of access frequency attribute being “3h” represents infrequent writes and frequent reads to the LBA range indicated. The value of access frequency attribute being “4h” represents frequency writes and infrequent reads to the LBA range indicated. The value of access frequency attribute being “5h” represents frequency writes and frequent reads to the LBA range indicated. The value of access frequency attribute being “6h” represents one time read to the LBA range indicated. The processing unit 134 increases the hot-data scores of all related data blocks in the hot-data scoring table by 1 when the value of access frequency attribute carried in the executed host write command is “3h”. The processing unit 134 increases the hot-data scores of all related data blocks in the hot-data scoring table by 2 when the value of access frequency attribute carried in the executed host write command is “4h”. The processing unit 134 increases the hot-data scores of all related data blocks in the hot-data scoring table by 3 when the value of access frequency attribute carried in the executed host write command is “5h”. Otherwise, the processing unit 134 maintains the hot-data scores in the hot-data scoring table.

In alternative embodiments, each of the hot-data scores of all related data blocks is increased by the multiplication of the first value by the length of the logical address range when the access frequency information indicates that the logical address range of user data to be read, which is instructed by the host read command, has infrequent writes and infrequent reads. Each of the hot-data scores of all related data blocks is increased by the multiplication of the second value by the length of the logical address range when the access frequency information indicates that the logical address range of user data to be read, which is instructed by the host read command, has infrequent writes and frequent reads. Each of the hot-data scores of all related data blocks is increased by the multiplication of the third value by the length of the logical address range when the access frequency information indicates that the logical address range of user data to be read, which is instructed by the host read command, has frequency writes and frequent reads. The first value, the second value and the third value are integers greater than 0, where the first value is smaller than the second value, and the second value is smaller than the third value.

Each time a new host read command is executed, the processing unit 134 updates the hot-data scores associated with all read data blocks in the hot-data scoring table. The processing unit 134 drives the flash I/F 139 to program the up-to-date hot-data scoring table into the designated physical address of the flash module 150 after updating the hot-data scoring table for a predetermined number of data blocks.

The exemplary hot-data scoring table is shown as Table 1:

TABLE 1

| Block# | Hot-data Score |
|---|---|
| #1 | 2200 |
| #2 | 599 |
| #3 | 1242 |
| #4 | 805 |

Table 1 indicates that the hot-data scores of the data blocks DBK #1, #2, #3 and #4 are 2200, 599, 1242 and 805, respectively.

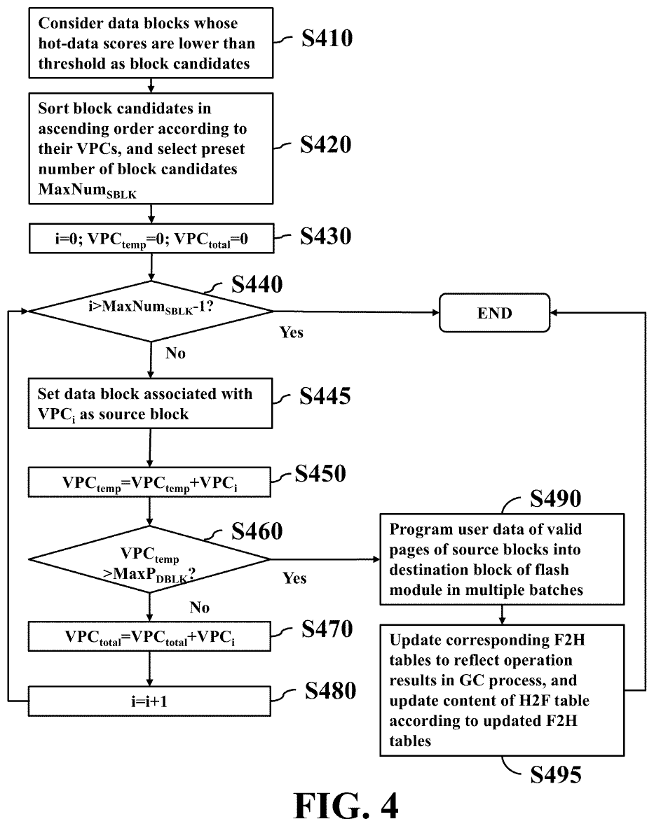

The flash controller 130 (specifically, the processing unit 134) performs a method for the GC process when detecting that a total number of available SBs (also referred to as empty SBs) in the flash module 150 is less than a threshold. Refer to FIG. 4 showing the method for the GC process performed by the processing unit 134 when loading and executing program code of the firmware translation layer (FTL). Details are described as follows:

Step S410: The data blocks whose hot-data scores are lower than a threshold are selected as block candidates according to the records of the hot-data scoring table. For example, referring to the examples as shown in Table 1, if the threshold is set to 1000, the data blocks DBK #2 and DBK #4 are selected as the block candidates. In other words, the data blocks DBK #1 and DBK #3 (that is, the data blocks containing more hot data) are excluded from the block candidates to avoid increasing WAF due to unnecessary hot-data migrations. In some embodiments, the processing unit 134 drives the flash I/F 139 to read the hot-data scoring table from the designated physical address of the flash module 150, and obtains the hot-data scores of all data blocks from the hot-data scoring table. Subsequently, the processing unit 134 selects block candidates from all blocks according to the obtained hot-data scores and the filtering condition as described above.

Step S420: The block candidates are sorted in ascending order according to their VPCs, and a preset number of block candidates MaxNum_{SBLK} (e.g. 16) are selected starting from the block candidate with the smallest VPC. In some embodiments, the processing unit 134 drives the flash I/F 139 to read its VPC from the metadata region of the designated physical page (for example, the last physical page) of each data block in the flash module 150. In alternative embodiments, the processing unit 134 drives the flash I/F 139 to read the VPC table from the designated physical address of the flash module 150, and obtains the VPCs of all data blocks from the VPC table. Subsequently, the processing unit 134 sorts all data blocks in ascending order according to the obtained VPCs.

Step S430: The variables i, VPCₜₑₘₚ and VPCₜₒₜₐₗ are set to 0. The processing unit 134 uses the variable i to record the serial number of the source block that is processed currently, and uses the variables VPCₜₑₘₚ and VPCₜₒₜₐₗ to record the accumulated VPCs of the source blocks so far. In the whole process, the processing unit 134 ensures that VPCₜₒₜₐₗ does not exceed two times MaxP_{DBLK}, the maximum number of pages that can be programmed into one destination block.

Step S440: It is determined whether the variable i is greater than MaxNum_{SBLK}−1. If so, it means that user data of valid pages in all source blocks can be programmed into the destination block, and the process ends. Otherwise, the process proceeds to step S445.

Step S445: The data block associated with VPCᵢ is set as the source block.

Step S450: VPCₜₑₘₚ=VPCₜₑₘₚ+VPCᵢ is calculated, where VPCᵢ represents the VPC of the i^{th} source block.

Step S460: It is determined whether the variable VPCₜₑₘₚ is greater than MaxP_{DBLK}, the maximum number of pages that can be programmed into one destination block. If so, it means that VPCs accumulated to the i^{th} source blocks have exceeded MaxP_{DBLK}, the maximum number of pages that can be programmed into one destination block, and the process proceeds to step S490. Otherwise, the process proceeds to step S470.

Step S470: VPCₜₒₜₐₗ=VPCₜₒₜₐₗ+VPCᵢ is calculated, where VPCᵢ represents the VPC of the i^{th} source block.

Step S480: The variable i is increased by one.

Step S490: User data of valid pages in the source blocks is programmed into the destination block of the flash module 150 in multiple batches. In some embodiments, the processing unit 134 operates for a preset time period in each batch to sequentially program the user data of the unwritten valid pages in the source blocks into the empty pages of the destination block in the flash module 150. In alternative embodiments, the processing units sequentially programs the user data of the preset number of unwritten valid pages in the source blocks into the empty pages of the destination block in the flash module 150 in each batch.

Step S495: The corresponding F2H table is updated to reflect the operation results of the GC process, where the updated F2H tables include the F2H tables corresponding to the source blocks and the destination block. Subsequently, the content of H2F table is updated according to the updated F2H tables.

In some embodiments, each source block is SLC SB, and the destination block is non-SLC SB (for example, MLC SB, TLC SB or QLC SB). Under such configuration, through the selection of block candidates as described above, hot data is migrated to the non-SLC SB from the SLC SB as few as possible in the GC process. Since most of hot data is stored in the SLC SB, the device side would take better read performance.

Although the invention is illustrated and described herein with reference to specific embodiments, the invention is not intended to be limited to the details shown. Rather, various modifications may be made in the details within the scope and range of equivalents of the claims and without departing from the invention. It is to be understood that the above description is illustrative of the invention and is not to be construed as limiting the invention. Various modifications, applications and/or combinations of the embodiments may occur to those skilled in the art without departing from the scope of the invention as defined by the claims.

One having ordinary skill in the art will readily understand that the invention as discussed above may be practiced with hardware elements in configurations which are different than those which are disclosed. Therefore, although the invention has been described based upon these preferred embodiments, it would be apparent to those skilled in the art that certain modifications, variations, and alternative constructions would be apparent, while remaining within the scope of the invention.

The present invention will be described with respect to particular embodiments and with reference to certain drawings, but the invention is not limited thereto and is only limited by the claims. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent.” etc.)

The term “device” or “module” is not limited to one or a specific number of physical objects (such as one smartphone, one controller, one processing system and so on). As used herein, a device may be any electronic device with one or more parts that may implement at least some portions of the invention in this disclosure. While the description and examples use the term “device” or “module” to describe various aspects of this disclosure, the term “device” or “module” is not limited to a specific configuration, type, or number of objects. Additionally, the term “system” or “module” is not limited to multiple components or specific aspects. For example, a system may be implemented on one or more printed circuit boards or other substrates and may have movable or static components. While the description and examples use the term “system” to describe various aspects of the invention in this disclosure, the term “system” is not limited to a specific configuration, type, or number of objects.

Specific details are provided in the description above to provide a thorough understanding of the aspects and examples provided herein. However, it will be understood by one of ordinary skills in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Some or all of the aforementioned embodiments of the method of the invention may be implemented in a computer program such as a driver for a dedicated hardware, a Firmware Translation Layer (FTL) of a storage device, or others. Other types of programs may also be suitable, as previously explained. Since the implementation of the various embodiments of the present invention into a computer program can be achieved by the skilled person using his routine skills, such an implementation will not be discussed for reasons of brevity. The computer program implementing some or more embodiments of the method of the present invention may be stored on a suitable computer-readable data carrier, or may be located in a network server accessible via a network such as the Internet, or any other suitable carrier.

A computer-readable storage medium includes volatile and non-volatile, removable and non-removable media implemented in any method or technology for storage of information such as computer-readable instruction, data structures, program modules, or other data. A computer-readable storage medium includes, but is not limited to, RAM, ROM, EEPROM, flash memory or other memory, CD-ROM, digital versatile disks (DVD), Blue-ray disk or other optical storage, magnetic cassettes, magnetic tape, magnetic disk or other magnetic storage devices, or any other medium which can be used to store the desired information and may be accessed by an instruction execution system. Note that a computer-readable medium can be paper or other suitable medium upon which the program is printed, as the program can be electronically captured via, for instance, optical scanning of the paper or other suitable medium, then compiled, interpreted, or otherwise processed in a suitable manner, if necessary, and then stored in a computer memory.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

The various illustrative logical blocks, modules, engines, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, engines, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

Although the embodiment has been described as having specific elements in FIGS. 1-3, it should be noted that additional elements may be included to achieve better performance without departing from the spirit of the invention. Each element of FIGS. 1-3 is composed of various circuitries and arranged to operably perform the aforementioned operations. While the process flows described in FIG. 4 include a number of operations that appear to occur in a specific order, it should be apparent that these processes can include more or fewer operations, which can be executed serially or in parallel (e.g., using parallel processors or a multi-threading environment).

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

1. A method for garbage collection (GC) in a flash storage device, performed by a processing unit, comprising:
considering a plurality of data blocks whose hot-data scores are lower than a threshold as a plurality of block candidates according to a plurality of records in a hot-data scoring table;
sorting the block candidates in ascending order according to a plurality of valid page counts (VPCs) associated with the block candidates;
starting from a block candidate with a smallest VPC, selecting a plurality of source blocks from sorted block candidates in which valid user data can fill one destination block; and
programming valid user data of the source blocks into a destination block in a flash module.

2. The method of claim 1, comprising:
updating a plurality of flash-address to host-address mapping (F2H) tables associated with the source blocks and the destination block to reflect programming results; and
updating content of a host-address to flash-address mapping (H2F) table according to updated F2H tables.

3. The method of claim 1, wherein each record stores a hot-data score of a corresponding data block.

4. The method of claim 3, comprising:
updating a hot-data score of a current block according to first access frequency information carried in a host write command during a data write operation for executing the host write command; and
appending a record to the hot-data scoring table for storing a hot-data score of a new data block after the current block is filled up and becomes the new data block.

5. The method of claim 4, comprising:
increasing the hot-data score of the current block by a first value, or by a multiplication of the first value by a length of a first logical address range when the first access frequency information indicates that the first logical address range of user data to be written, which is instructed by the host write command, has infrequent writes and infrequent reads;
increasing the hot-data score of the current block by a second value, or by a multiplication of the second value by the length of the first logical address range when the first access frequency information indicates that the first logical address range of user data to be written, which is instructed by the host write command, has infrequent writes and frequent reads; and
increasing the hot-data score of the current block by a third value, or by a multiplication of the third value by the length of the first logical address range when the first access frequency information indicates that the first logical address range of user data to be written, which is instructed by the host write command, has frequent writes and frequent reads,
wherein the first value, the second value and the third value are integers greater than 0, the first value is smaller than the second value, and the second value is smaller than the third value.

6. The method of claim 4, comprising:
updating the hot-data scoring table according to second access frequency information carried in a host read command during a data read operation for executing the host read command.

7. The method of claim 6, comprising:
increasing a plurality of hot-data scores associated with a plurality of read data blocks by a first value, or by a multiplication of the first value by a length of a second logical address range when the second access frequency information indicates that the second logical address range of user data to be read, which is instructed by the host read command, has infrequent writes and infrequent reads;
increasing the hot-data scores associated with the read data blocks by a second value, or by a multiplication of the second value by the length of the second logical address range when the second access frequency information indicates that the second logical address range of user data to be read, which is instructed by the host read command, has infrequent writes and frequent reads; and
increasing the hot-data scores associated with the read data blocks by a third value, or by a multiplication of the third value by the length of the second logical address range when the second access frequency information indicates that the second logical address range of user data to be read, which is instructed by the host read command, has frequent writes and frequent reads,
wherein the first value, the second value and the third value are integers greater than 0, the first value is smaller than the second value, and the second value is smaller than the third value.

8. A non-transitory computer-readable storage medium having stored therein program code that, when loaded and executed by a processing unit, causes the processing unit to:
consider a plurality of data blocks whose hot-data scores are lower than a threshold as a plurality of block candidates according to a plurality of records in a hot-data scoring table;
sort the block candidates in ascending order according to a plurality of valid page counts (VPCs) associated with the block candidates;
starting from a block candidate with a smallest VPC, select a plurality of source blocks from sorted block candidates in which valid user data can fill one destination block; and
program valid user data of the source blocks into a destination block in a flash module.

9. The non-transitory computer-readable storage medium of claim 8, wherein each record stores a hot-data score of a corresponding data block.

10. The non-transitory computer-readable storage medium of claim 9, wherein the program code that, when loaded and executed by the processing unit, causes the processing unit to:
update a hot-data score of a current block according to first access frequency information carried in a host write command during a data write operation for executing the host write command; and
append a record to the hot-data scoring table for storing a hot-data score of a new data block after the current block is filled up and becomes the new data block.

11. The non-transitory computer-readable storage medium of claim 10, wherein the program code that, when loaded and executed by the processing unit, causes the processing unit to:
increase the hot-data score of the current block by a first value, or by a multiplication of the first value by a length of a first logical address range when the first access frequency information indicates that the first logical address range of user data to be written, which is instructed by the host write command, has infrequent writes and infrequent reads;
increase the hot-data score of the current block by a second value, or by a multiplication of the second value by the length of the first logical address range when the first access frequency information indicates that the first logical address range of user data to be written, which is instructed by the host write command, has infrequent writes and frequent reads; and
increase the hot-data score of the current block by a third value, or by a multiplication of the third value by the length of the first logical address range when the first access frequency information indicates that the first logical address range of user data to be written, which is instructed by the host write command, has frequent writes and frequent reads,
wherein the first value, the second value and the third value are integers greater than 0, the first value is smaller than the second value, and the second value is smaller than the third value.

12. The non-transitory computer-readable storage medium of claim 10, wherein the program code that, when loaded and executed by the processing unit, causes the processing unit to:
update the hot-data scoring table according to second access frequency information carried in a host read command during a data read operation for executing the host read command.

13. The non-transitory computer-readable storage medium of claim 12, wherein the program code that, when loaded and executed by the processing unit, causes the processing unit to:
increase a plurality of hot-data scores associated with a plurality of read data blocks by a first value, or by a multiplication of the first value by a length of a second logical address range when the second access frequency information indicates that the second logical address range of user data to be read, which is instructed by the host read command, has infrequent writes and infrequent reads;
increase the hot-data scores associated with the read data blocks by a second value, or by a multiplication of the second value by the length of the second logical address range when the second access frequency information indicates that the second logical address range of user data to be read, which is instructed by the host read command, has infrequent writes and frequent reads; and
increase the hot-data scores associated with the read data blocks by a third value, or by a multiplication of the third value by the length of the second logical address range when the second access frequency information indicates that the second logical address range of user data to be read, which is instructed by the host read command, has frequent writes and frequent reads,
wherein the first value, the second value and the third value are integers greater than 0, the first value is smaller than the second value, and the second value is smaller than the third value.

14. An apparatus for garbage collection (GC) in a flash storage device, comprising:
a flash interface (I/F), coupled to a flash module; and
a processing unit, coupled to the flash I/F, arranged operably to: consider a plurality of data blocks whose hot-data scores are lower than a threshold as a plurality of block candidates according to a plurality of records in a hot-data scoring table; sort the block candidates in ascending order according to a plurality of valid page counts (VPCs) associated with the block candidates; starting from a block candidate with a smallest VPC, select a plurality of source blocks from sorted block candidates in which valid user data can fill one destination block; and drive the flash I/F to program valid user data of the source blocks into a destination block in the flash module.

15. The apparatus of claim 14, wherein the processing unit is arranged operably to: update a plurality of flash-address to host-address mapping (F2H) tables associated with the source blocks and the destination block to reflect programming results; and update content of a host-address to flash-address mapping (H2F) table according to updated F2H tables.

16. The apparatus of claim 14, wherein each record stores a hot-data score of a corresponding data block.

17. The apparatus of claim 16, wherein the processing unit is arranged operably to: update a hot-data score of a current block according to first access frequency information carried in a host write command during a data write operation for executing the host write command; and append a record to the hot-data scoring table for storing a hot-data score of a new data block after the current block is filled up and becomes the new data block.

18. The apparatus of claim 17,
wherein the processing unit is arranged operably to: increase the hot-data score of the current block by a first value, or by a multiplication of the first value by a length of a first logical address range when the first access frequency information indicates that the first logical address range of user data to be written, which is instructed by the host write command, has infrequent writes and infrequent reads; increase the hot-data score of the current block by a second value, or by a multiplication of the second value by the length of the first logical address range when the first access frequency information indicates that the first logical address range of user data to be written, which is instructed by the host write command, has infrequent writes and frequent reads; and increase the hot-data score of the current block by a third value, or by a multiplication of the third value by the length of the first logical address range when the first access frequency information indicates that the first logical address range of user data to be written, which is instructed by the host write command, has frequent writes and frequent reads,
wherein the first value, the second value and the third value are integers greater than 0, the first value is smaller than the second value, and the second value is smaller than the third value.

19. The apparatus of claim 17, wherein the processing unit is arranged operably to: update the hot-data scoring table according to second access frequency information carried in a host read command during a data read operation for executing the host read command.

20. The apparatus of claim 19,
wherein the processing unit is arranged operably to: increase a plurality of hot-data scores associated with a plurality of read data blocks by a first value, or by a multiplication of the first value by a length of a second logical address range when the second access frequency information indicates that the second logical address range of user data to be read, which is instructed by the host read command, has infrequent writes and infrequent reads; increase the hot-data scores associated with the read data blocks by a second value, or by a multiplication of the second value by the length of the second logical address range when the second access frequency information indicates that the second logical address range of user data to be read, which is instructed by the host read command, has infrequent writes and frequent reads; and increase the hot-data scores associated with the read data blocks by a third value, or by a multiplication of the third value by the length of the second logical address range when the second access frequency information indicates that the second logical address range of user data to be read, which is instructed by the host read command, has frequent writes and frequent reads,
wherein the first value, the second value and the third value are integers greater than 0, the first value is smaller than the second value, and the second value is smaller than the third value.
